(19) United States
(12) Patent Application Publication
(10) Pub. No.: US 2020/0365361 A1
(43) Pub. Date: Nov. 19, 2020

(54) CODED X-RAY TARGET

(71) Applicant: Sigray, Inc., Concord, CA (US)

(72) Inventors: Wenbing Yun, Walnut Creek, CA (US); David Vine, Berkeley, CA (US)

(21) Appl. No.: 16/412,990

(22) Filed: May 15, 2019

(51) Int. Cl. H01J 35/06; G21K 7/00

(52) U.S. Cl. CPC H01J 35/065; G21K 7/00; G01N 2223/1016; H01J 2235/1291; H01J 2235/081

(57) ABSTRACT

A target for generating x-rays includes at least one substrate including a first material and a plurality of discrete structures including at least one second material configured to generate x-rays in response to electron bombardment. The discrete structures are distributed across a first surface of the at least one substrate in an array pattern function A that has a corresponding function B such that a combination operation of the array pattern function A with the corresponding function B generates a resultant function C comprising a first portion with a single peak and a substantially flat second portion surrounding the first portion. The combination operation includes a cross-correlation operation or a convolution operation

### BACKGROUND

### Field

The present application relates generally to targets configured to generate x-rays in response to electron bombardment, x-ray sources utilizing such targets, and methods of using such x-ray sources.

### Description of the Related Art

X-ray microscopy in the micron and sub-micron resolution length scale is dominated by point projection microscopy (PPM). PPM offers high resolution by combining a small x-ray source size with (i) low geometric magnification and small detector pixels, or (ii) high geometric magnification and large detector pixels. In both cases, however, the use of a small x-ray spot limits the available x-ray flux because the electron power density of the electron beam bombarding the x-ray target is limited by an upper bound corresponding to excessive heat generation that would result in damage to the x-ray source.

Various efforts have been made to maximize the electron power density, including but not limited to, using an x-ray target comprising a diamond substrate to improve dissipation of the heat load or using a liquid metal jet target to obviate the problem of target damage. These and other efforts have increased the throughput of PPM, the technique has plateaued as the development has pushed materials and methods to their fundamental limits.

### SUMMARY

In one aspect disclosed herein, a target for generating x-rays is provided. The target comprises at least one substrate comprising a first material and a plurality of discrete structures comprising at least one second material configured to generate x-rays in response to electron bombardment. The discrete structures are distributed across a first surface of the at least one substrate in an array pattern function A that has a corresponding function B such that a combination operation of the array pattern function A with the corresponding function B generates a resultant function C comprising a first portion with a single peak and a substantially flat second portion surrounding the first portion. The combination operation comprises a cross-correlation operation or a convolution operation.

In another aspect disclosed herein, an x-ray source is provided. The x-ray source comprises a target comprising at least one substrate comprising a first material and a plurality of discrete structures comprising at least one second material configured to generate x-rays in response to electron bombardment. The discrete structures are distributed across a first surface of the at least one substrate in an array pattern function A that has a corresponding function B such that a combination operation of the array pattern function A with the corresponding function B generates a resultant function C comprising a first portion with a single peak and a substantially flat second portion surrounding the first portion. The combination operation comprises a cross-correlation operation or a convolution operation. The x-ray source further comprises at least one electron source configured to generate at least one electron beam and to bombard the target with the at least one electron beam.

In still another aspect disclosed herein, a method is provided. The method comprises providing an x-ray source comprising a target comprising at least one substrate comprising a first material and a plurality of discrete structures comprising at least one second material configured to generate x-rays in response to electron bombardment. The discrete structures are distributed across a first surface of the at least one substrate in an array pattern function A that has a corresponding function B such that a combination operation of the array pattern function A with the corresponding function B generates a resultant function C comprising a first portion with a single peak and a substantially flat second portion surrounding the first portion. The combination operation comprises a cross-correlation operation or a convolution operation. The x-ray source further comprises at least one electron source configured to generate at least one electron beam and to bombard the target with the at least one electron beam. The method further comprises bombarding the target with the at least one electron beam from the at least one electron source. The method further comprises irradiating at least a portion of an object with x-rays generated by the target in response to said bombarding. The method further comprises detecting at least one intensity distribution of x-rays transmitted through the portion of the object. The method further comprises applying a reconstruction algorithm to the detected at least one intensity distribution to generate at least one image of the portion of the object.

### BRIEF DESCRIPTION OF THE DRAWINGS

FIG. 1A schematically illustrates a cross-sectional view of an example target for generating x-rays in accordance with certain embodiments described herein.

FIG. 1B schematically illustrates an example resultant function C in accordance with certain embodiments described herein.

FIGS. 1C and 1D schematically illustrate portions of example targets comprising a series of structures that are substantially the same as one another in accordance with certain embodiments described herein.

FIG. 2A schematically illustrates an example x-ray source in accordance with certain embodiments described herein.

FIG. 2B schematically illustrates an example configuration of an x-ray source, an object being analyzed, and an x-ray detector in accordance with certain embodiments described herein.

FIGS. 3A and 3B schematically illustrate two example targets configured to improve the x-ray distribution from the target in accordance with certain embodiments described herein.

FIGS. 4A-4G illustrate top views of various example two-dimensional array pattern functions A in accordance with certain embodiments described herein.

FIG. 4H illustrates an example autocorrelation function (C=A*A) of each of the array pattern functions A of FIGS. 4A-4G in accordance with certain embodiments described herein.

FIGS. 5-14 illustrate various example two-dimensional array pattern functions A in accordance with certain embodiments described herein along with the corresponding autocorrelation functions (C=A*A) for each of the array pattern functions A.

FIGS. 15-16 illustrate additional example two-dimensional array pattern functions A in accordance with certain embodiments described herein.

FIG. 17 illustrates an additional example two-dimensional array pattern function A in accordance with certain embodiments described herein.

FIG. 18 is a flow diagram of an example method for analyzing an object in accordance with certain embodiments described herein.

FIGS. 19A and 19B schematically illustrate two example configurations of the x-ray source, the object being analyzed, and the x-ray detector in accordance with certain embodiments described herein.

FIGS. 20A and 20B schematically illustrate two example configurations of the x-ray source and the x-ray detector depicting a geometric field of view and resolution limit in accordance with certain embodiments described herein.

FIG. 21 schematically illustrates an example configuration on the right side in which the detector pixel size is not an integer multiple of the magnified source pixel and an example configuration on the left side in which the detector pixel size is an integer multiple of the magnified source pixel in accordance with certain embodiments described herein.

### DETAILED DESCRIPTION

Point projection microscopy (PPM) can be thought of as the inversion of a much older technology: the pinhole aperture camera. In a pinhole aperture camera, the light reflected from an object is projected through a small hole in an otherwise opaque wall onto a screen. The amount of light transmitted through the hole is proportional to the hole size (e.g., diameter) but the spatial resolution of the projected image (excluding diffraction effects) is inversely proportional to the hole size (i.e., smaller hole diameters provide better spatial resolution of the projected image but at the expense of the projected image being weaker). PPM is similar to the pinhole aperture camera, but with the positions of the small x-ray source (analogous to the pinhole aperture) and the object inverted. PPM has an analogous tradeoff between the source size and spatial resolution, and the desire to improve throughput in PPM (e.g., increasing the number of x-rays contributing to the image, thereby being able to reduce the amount of time in acquiring the image) is weighed against the desire for improved spatial resolution.

As a method to bypass the resolution/throughput tradeoff in the context of x-ray astronomy, a generalization of the pinhole aperture camera, referred to as the coded aperture camera, was first suggested by Dicke in 1968. The coded aperture camera included a screen with many small holes, collectively referred to as the aperture, with the cumulative area of the holes much greater than that of any single hole, thereby greatly increasing the amount of light transmitted by the aperture. The resulting projected image contained the superposition of the images from each of the small holes, which severely degraded the image quality. However, the small holes of the aperture were distributed relative to one another (e.g., coded) in such a way as to make the reduction in image quality reversible through computational analysis of the image. Subsequent research yielded various families of aperture distribution functions that had the desired property that their autocorrelation function was a delta function. Using such coded apertures, the process of acquiring an image could be viewed as a two-step procedure involving an encoding step where an object/scene was imaged with a coded aperture onto a detector that recorded a highly aberrated image, followed by a decoding step in which an algorithm implemented in a computer was used to recover the image of the object/scene from the aberrated image. Despite the aberrations of the recorded image being severe enough to render it unrecognizable from what was being imaged, there was no information lost in the recording process and therefore the image of the object/scene was able to be recovered without loss in a post-processing step. Another way to view the coded aperture concept is to consider the pixelated area detector as a multi-channel device with a predetermined bandwidth and the coded aperture as a mechanism to multiplex many signals to best take advantage of the available bandwidth.

Certain embodiments described herein utilize a coded x-ray target that can be considered analogous to the coded aperture camera, in a manner similar to the analogy between PPM and the pinhole aperture camera. In certain such embodiments, the coded x-ray target comprises many small sub-sources of x-rays, the sub-sources arranged in such a way that the resultant image produced by the x-ray detector is capable of being inverted computationally (e.g., analytically or iteratively) without loss of information. The throughput gain of certain embodiments is proportional to the square root of the number of individual sub-sources of the coded x-ray source and the spatial resolution of certain embodiments is given by the size of the individual sub-sources and by the size of the pixels of the x-ray detector (e.g., as in PPM).

Certain embodiments described herein advantageously provide improvements in throughput as compared to the PPM (e.g., up to a theoretical factor of the square root of the number of individual sub-sources of the coded x-ray source). For example, certain embodiments can be used in x-ray microscopy systems to enable high throughput, high resolution imaging (e.g., imaging down to a submicron scale, such as 0.3 micron can be achieved). For another example, certain embodiments can be used in three-dimensional x-ray microscopy by rotating the sample relative to the x-rays to acquire tomography data.

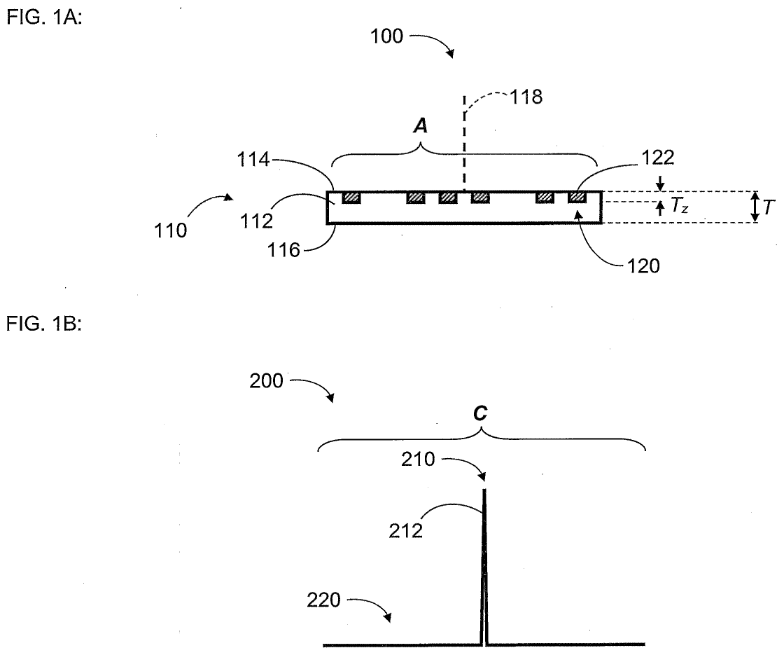

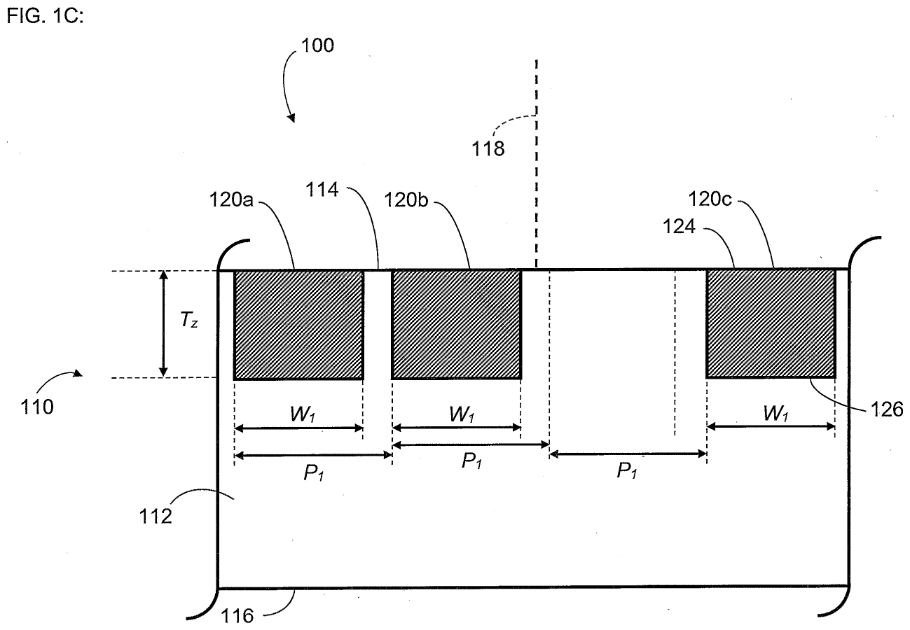

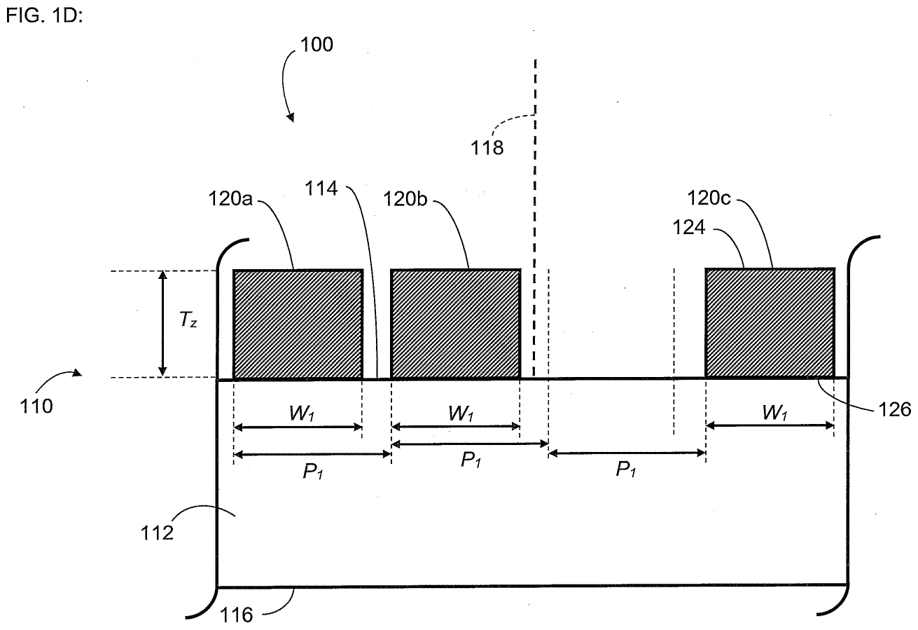

FIG. 1A schematically illustrates a cross-sectional view of an example target 100 for generating x-rays in accordance with certain embodiments described herein. The target 100 comprises at least one substrate 110 comprising a first material 112 and a plurality of discrete structures 120 comprising at least one second material 122 configured to generate x-rays in response to electron bombardment. The discrete structures 120 are distributed across a first surface 114 of the at least one substrate 110 in an array pattern function A that has a corresponding function B such that a combination operation of the array pattern function A with the corresponding function B generates a resultant function C 200. FIG. 1B schematically illustrates an example resultant function C 200 in accordance with certain embodiments described herein. The resultant function C 200 comprises a first portion 210 with a single peak 212 and a substantially flat second portion 220 surrounding the first portion 210. The combination operation comprises a cross-correlation operation (e.g., the resultant function C 200 comprises a cross-correlation function of the array pattern function A with the corresponding function B) or a convolution operation (e.g., the resultant function C 200 comprises a convolution function of the array pattern function A with the corresponding function B).

In certain embodiments, the first material 112 of the at least one substrate 110 comprises a thermally conductive first material. For example, the first material 112 can comprise at least one of: diamond, beryllium, and sapphire.

In certain embodiments, the at least one substrate 120 comprises at least one body (e.g., wafer; plate; lamina) comprising the first surface 114 and a second surface 116 opposite to the first surface 114 (e.g., as schematically illustrated in FIG. 1A). The second surface 116 of certain embodiments is generally parallel to the first surface 114 (e.g., as schematically illustrated in FIG. 1A), while in certain other embodiments, the first surface 114 and the second surface 116 are non-parallel to one another. For example, the second surface 116 can be at a non-zero angle relative to the first surface 114, with the non-zero angle in a range greater than zero and less than 15 degrees or a range from 15 degrees to 45 degrees.

The at least one substrate 110 of certain embodiments is planar and has a substantially flat first surface 114 and a substantially flat second surface 116 (e.g., as schematically illustrated in FIG. 1A), while in certain other embodiments, the at least one substrate 110 is non-planar and/or at least one of the first surface 114 and the second surface 116 is curved, stepped, or otherwise deviates from being flat. While FIG. 1A schematically illustrates an example substrate 110 in which the surface normal 118 is uniform across the first surface 114 (e.g., different sub-portions of the first surface 114 have surface normals 118 that are parallel to one another and that point in the same direction as one another), the surface normal 118 can be non-uniform across the first surface 114 (e.g., different sub-portions of the first surface 114 have surface normals that are non-parallel and that point in different directions as one another).

In certain embodiments, the at least one substrate 110 has a thickness T (e.g., between the first surface 114 and the second surface 116) in a range of 100 microns to 250 microns, in a range of 250 microns to 3000 microns, in a range of 250 microns to 1000 microns, or in a range of less than 1000 microns. The thickness T of the at least one substrate 110 of certain embodiments is uniform across the at least one substrate 110, while in other certain embodiments, the thickness T of the at least one substrate 110 is different in different portions of the at least one substrate 110.

In certain embodiments, the discrete structures 120 are on and/or at least partially embedded in at least a portion of the first surface 114. For example, as schematically illustrated by FIGS. 1A and 1C), the structures 120 are at least partially embedded in the first surface 114 (e.g., with the top surfaces 124 of the structures 120 below, above, or flush with the first surface 114 and the bottom surfaces 126 of the structures 120 below the first surface 114). For another example, as schematically illustrated by FIG. 1D, the structures 120 are on the first surface 114 (e.g., the structures 120 are deposited or affixed onto the first surface 114 with the top surfaces 124 of the structures 120 above the first surface 114 and the bottom surfaces 126 of the structures 120 flush with the first surface 114). The structures 120 of certain embodiments are separate from one another and are in thermal communication with the at least one substrate 110. The at least one second material 122 of the structures 120 is different from the first material 112, and the at least one second material is configured to generate x-rays upon bombardment (e.g., irradiation) by electrons having energies in an energy range of 0.5 keV to 160 keV.

In certain embodiments, the at least one second material 122 of the structures 120 is selected to generate x-rays having a predetermined energy spectrum (e.g., x-ray intensity distribution as function of x-ray energy) upon irradiation by electrons having energies in the energy range of 0.5 keV to 160 keV. Examples of the at least one second material 122 include but are not limited to, at least one of: tungsten, gold, molybdenum, chromium, copper, aluminum, rhodium, platinum, iridium, and cobalt. While FIGS. 1A, 1C, and 1D schematically illustrate the structures 120 having a rectangular cross-sections with substantially straight sides, any other shape (e.g., regular; irregular; geometric; non-geometric) with straight, curved, and/or irregular sides is also compatible with certain embodiments described herein.

In certain embodiments, the structures 120 have a thickness T_{z} between the top surface 124 and the bottom surface 126 in a range of 1 micron to 40 microns, in a range of 3 microns to 40 microns, in a range of 1 micron to 10 microns, in a range of 1 micron to 5 microns, in a range of 5 microns to 10 microns, or in a range of less than 7 microns. For example, as schematically illustrated by FIG. 1C, for structures 120 embedded in the first surface 114 with the top surface 124 flush with the first surface 114, the structures 120 extend from the first surface 114 towards the second surface 116 to a depth equal to T_{z}. For another example, as schematically illustrated by FIG. 1D, for structures 120 on the first surface 114 with the bottom surface 126 flush with the first surface 114, the structures 120 extend from the first surface 114 away from the second surface 116 by the thickness T_{z}. In certain other embodiments, the structures 120 are partially embedded within the first surface 114 and extend above the first surface 114.

In certain embodiments, the thickness T_{z} is selected based at least in part on the kinetic energy of the electrons used to bombard the structures 120 to generate x-rays, since the electron penetration depth is dependent on the electron kinetic energy and the material through which the electrons travel. For example, for structures 120 comprising gold, the thickness T_{z} can be selected to be in a range of 2 microns to 4 microns for 20 keV electrons, and to be in a range of 4 microns to 6 microns for 40 keV electrons.

In certain embodiments, the structures 120 are arranged across the first surface 114 of the at least one substrate 110 in a one-dimensional array (e.g., distributed relative to one another in a one-dimensional pattern extending along a direction parallel to the first surface 114) or in a two-dimensional array (e.g., distributed relative to one another in a two-dimensional pattern extending along two orthogonal directions both parallel to the first surface 114). For example, the structures 120 can comprise elongate strips or “lines” of the at least one second material 122 that are spaced from one another and substantially parallel to one another (e.g., in a pattern having a one-dimensional array pattern function Aₘ). For another example, the structures 120 can comprise blocks, hexagonal (e.g., “honeycomb”) prisms, or “dots” (e.g., cylinders) of the at least one second material 122 that are spaced from one another in two lateral directions that are both perpendicular to one another and parallel to the first surface 114 (e.g., in a pattern having a two-dimensional array pattern function A_{m,n}).

In certain embodiments, at least some of the structures 120 each extend by a width W along the first surface 114 in at least one lateral direction (e.g., a direction parallel to the first surface 114) and the array pattern function A has a periodicity distance P (e.g., a distance between the periodic array locations at which the structures 120 are or are not positioned according to the array pattern function A) along the first surface 114 in the at least one lateral direction. For example, FIGS. 1C and 1D schematically illustrate a portion of example targets 100 comprising a series of structures 120 that are substantially the same as one another in accordance with certain embodiments described herein (e.g., in which the structures 120 are distributed along the first surface 114 in a one-dimensional array or a two-dimensional array). The structures 120 each have a width W₁ in a first lateral direction (e.g., a first direction parallel to the first surface 114) and are distributed across the first surface 114 in the first lateral direction with a periodicity distance P₁ (e.g., a distance between equivalent portions of the array locations; a center-to-center distance). In certain embodiments, the width W₁ of at least some of the structures 120 in the first lateral direction is in a range of 0.1 micron to 100 microns, in a range of 0.1 micron to 10 microns, in a range of 0.1 micron to 5 microns, in a range of 0.1 micron to 1 micron, in a range of 0.1 micron to 0.4 micron, or in a range of 0.5 micron to 1 micron, and the periodicity distance P₁ for the structures 120 in the first lateral direction is in a range of 0.1 micron to 100 microns, in a range of 0.1 micron to 10 microns, in a range of 0.1 micron to 5 microns, in a range of 0.1 micron to 1 micron, in a range of 0.1 micron to 0.4 micron, in a range of 0.5 micron to 1 micron, or in a range of 1 micron to 100 microns. In certain embodiments, structures 120a,b that are on adjacent array locations along the first lateral direction (according to the array pattern function A) are spaced from one another along the first lateral direction (e.g., W₁<P₁), as schematically illustrated by FIGS. 1C and 1D, while in certain other embodiments, structures 120a,b contact one another or are otherwise mechanically coupled to one another (e.g., W₁=P₁). As schematically illustrated by FIGS. 1C and 1D, according to the array pattern function A, an array position between structure 120b and structure 120c along the first lateral direction does not have a corresponding structure 120.

In certain embodiments (e.g., in which the structures 120 are arranged in a two-dimensional array), the structures 120 also have a width W₂ in a second lateral direction (e.g., a second direction parallel to the first surface 114 and perpendicular to the first lateral direction) and are distributed across the first surface 114 in the second lateral direction with a periodicity distance P₂ (e.g., a distance between equivalent portions of the array locations; a center-to-center distance). In certain embodiments, the width W₂ of at least some of the structures 120 in the second lateral direction is in a range of 0.1 micron to 100 microns, in a range of 0.1 micron to 10 microns, in a range of 0.1 micron to 5 microns, in a range of 0.1 micron to 1 micron, in a range of 0.1 micron to 0.4 micron, or in a range of 0.5 micron to 1 micron, and the periodicity distance P₂ for the structures 120 in the second lateral direction is in a range of 0.1 micron to 100 microns, in a range of 0.1 micron to 10 microns, in a range of 0.1 micron to 5 microns, in a range of 0.1 micron to 1 micron, in a range of 0.1 micron to 0.4 micron, in a range of 0.5 micron to 1 micron, or in a range of 1 micron to 100 microns. In certain embodiments, structures 120 that are on adjacent array locations along the second lateral direction (according to the array pattern function A) are spaced from one another along the second lateral direction (e.g., W₂<P₂), while in certain other embodiments, adjacent structures 120 contact one another or are otherwise mechanically coupled to one another (e.g., W₂=P₂). In certain embodiments (e.g., in which the structures 120 are arranged in linear-type array), the structures 120 have a width W₂ that is substantially larger than W₁.

In certain embodiments, the target 100 further comprises at least one interface layer between the first material 112 and the at least one second material 122, and the at least one interface layer comprises at least one third material different from the first material 112 and the at least one second material 122. Examples of the at least one third material include but are not limited to, at least one of: titanium nitride (e.g., used with a first material 112 comprising diamond and a second material 122 comprising tungsten), iridium (e.g., used with a first material 112 comprising diamond and a second material 122 comprising molybdenum and/or tungsten), chromium (e.g., used with a first material 112 comprising diamond and a second material 122 comprising copper), beryllium (e.g., used with a first material 112 comprising diamond), hafnium oxide, TiC/TiN, and a variety of carbides (e.g., silicon carbide, beryllium carbide, titanium carbide, tungsten carbide). In certain embodiments, the at least one interface layer has a thickness in a range of 1 nanometer to 5 nanometers or in a range of 2 nanometers to 30 nanometers. In certain embodiments, the at least one third material is selected to provide a diffusion barrier layer configured to avoid (e.g., prevent; reduce; inhibit) diffusion of the at least one second material 122 (e.g., tungsten) into the first material 112 (e.g., diamond), to enhance (e.g., improve; facilitate) adhesion between the at least one second material 122 and the first material 112, and/or to enhance (e.g., improve; facilitate) thermal conductivity between the at least one second material 122 and the first material 112.

In certain embodiments, the target 100 further comprises at least one layer overlaying the structures 120 (e.g., at the first surface 114 for structures 120 embedded in the first surface 114 as schematically illustrated by FIG. 1C). The at least one layer of certain embodiments comprises an electrically conductive material (e.g., doped diamond; nickel; aluminum) configured to be in electrical communication with electrical ground or another electrical potential to prevent charging of the structures 120 and/or the first surface 114 due to electron irradiation of the target 100 and/or a sealing material (e.g., the first material; diamond; beryllium; sapphire) configured to seal the structures 120 between the at least one layer and the substrate 110.

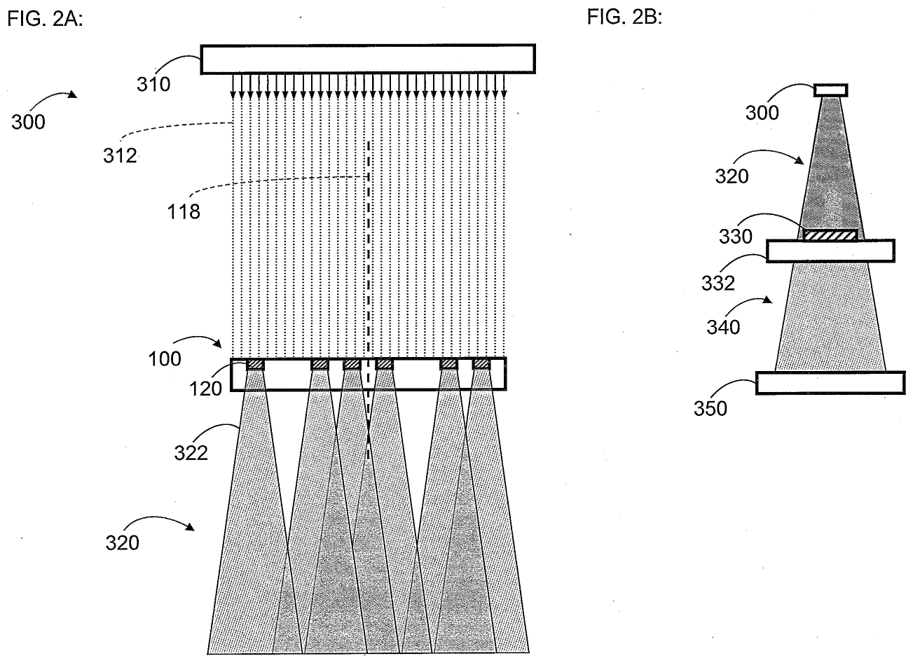

FIG. 2A schematically illustrates an example x-ray source 300 in accordance with certain embodiments described herein. The x-ray source 300 comprises the target 100 and at least one electron source 310 configured to generate at least one electron beam 312 and to bombard the target 100 with the at least one electron beam 312. In certain embodiments, the at least one electron source 310 comprises an electron emitter having a dispenser cathode (e.g., impregnated tungsten), tungsten filament, lanthanum hexaboride (LaB₆) cathode, or carbon nanotubes configured to emit electrons (e.g., via thermionic or field emission) to be directed to impinge the target 100 (e.g., at ground voltage). The at least one electron source 310 of certain embodiments further comprises electron optics components (e.g., deflection electrodes; grids; electrostatic lens; magnetic lens; etc.) configured to deflect, shape, and/or focus the at least one electron beam 312 (e.g., such that the electron beam has a gaussian cross-sectional distribution), to accelerate the at least one electron beam 312 to a predetermined electron kinetic energy (e.g., in a range of 0.5 keV to 160 keV or in any other range that is selected to provide x-rays with a predetermined energy spectrum), and to direct the at least one electron beam 312 onto the target 100. The at least one electron beam 312 can bombard the target 100 along a direction parallel to the surface normal 118 of the first surface 114 or along a direction at a non-zero angle relative to the surface normal 118 (e.g., 45 degrees; 60 degrees). In certain embodiments, the at least one electron beam 312 has a cross-sectional area (e.g., in a plane substantially perpendicular to a propagation direction of the at least one electron beam 312) that is greater than or equal to an area of the array pattern function A across the first surface 114 (e.g., having a width that is greater than or equal to 10 microns, 100 microns, or 250 microns). In certain embodiments, the at least one electron source 310 is configured to deflect the at least one electron beam 312 to bombard a selected portion of the target 100 (e.g., to scan the at least one electron beam 312 across the structures 120 over time; to bombard a selected one or more sub-arrays of the structures 120).

In certain embodiments, the structures 120 bombarded by the at least one electron beam 312 generate x-rays, with the individual structures 120 serving as separate x-ray emitters (e.g., separate x-ray sub-sources). In certain embodiments, the x-rays are emitted from the target 100 (e.g., through the second surface 116) in an x-ray beam 320 comprising a plurality of x-ray sub-beams 322, each x-ray sub-beam 322 propagating from a corresponding one of the structures 120. In this way, the x-ray sub-beams 322 of the x-ray beam 320 propagating from the target 100 are distributed relative to one another in the same array pattern function A as are the structures 120. In certain embodiments, the x-ray beam 320 generated by the structures 120 advantageously retains the array pattern function A of the structures 120, independent of the energy of the at least one electron beam 312 bombarding the structures 120 (e.g., in contrast to an unstructured metal target that would suffer from a blooming of the source size for high electron energies due to scattering). While FIG. 2A schematically illustrates the x-ray beam 320 being transmitted through at least a portion of the substrate 110 (e.g., through the second surface 116; in a transmission configuration), in certain other embodiments, the x-ray beam 320 is directed from the first surface 114 in a direction away from the substrate 110 (e.g., in a direction extending away from the second surface 116; in a direction having a component opposite to the propagation direction of the incident electrons; in a reflection configuration) with the x-ray beam 320 retaining the array pattern function A of the structures 120.

FIG. 2B schematically illustrates an example configuration of an x-ray source 300, an object 330 being analyzed, and an x-ray detector 350 in accordance with certain embodiments described herein. The x-ray source 300 is configured to irradiate the object 330 with the x-ray beam 320 comprising the plurality of x-ray sub-beams 322. The x-ray detector 350 is configured to detect at least a transmitted portion 340 of the x-ray beam 320 that is transmitted through the object 330. In certain embodiments, the entire object 330 is irradiated by x-ray beam 320 from the x-ray source 300, while in certain other embodiments, only a portion of the object 330 is irradiated by the x-ray beam 320. In certain embodiments, the object 330 is coupled to a stage 332 configured to support the object 300 while not adversely affecting the incident x-ray beam 320 or the transmitted portion 340 of the x-ray beam 320 (e.g., not blocking a substantial portion of the incident x-ray beam 320 or the transmitted portion 340 of the x-ray beam 320). The stage 332 of certain embodiments is configured to adjust a position of the object relative to the incident x-ray beam 320. For example, the stage 332 can be configure to move the object 330 in one, two, and/or three dimensions (e.g., in x, y, and z directions orthogonal to one another) relative to the x-ray beam 320 and/or to rotate the object 330 about one, two, or three axes of rotation that can be orthogonal to one another.

In certain embodiments, the x-ray detector 350 comprises a pixel array configured to record a spatial distribution of at least a portion of the transmitted x-rays 340 received from the object 330. For example, the pixel array can be one-dimensional or can be two-dimensional, with pixel sizes in a range from 3 microns to 200 microns. Example detectors compatible with certain embodiments described herein include but are not limited to: direct-detection charge-coupled-device (CCD) detector, complementary metal-oxide-semiconductor (CMOS) detector, energy-resolving x-ray detector, indirect conversion detector comprising an x-ray scintillator, a photon counting detector, or any combination thereof.

Other x-rays generated in and emitted by the substrate 110 can adversely degrade the resultant total x-ray distribution emitted from the x-ray target 100. For example, the substrate-generated x-rays can adversely degrade (e.g., reduce) the discrimination of the structures 120 as separate x-ray emitters of the desired x-ray spatial distribution (e.g., spatially distinct x-ray sub-sources distributed in the array pattern function A). For another example, the substrate-generated x-rays can adversely degrade a desired x-ray energy spectrum (e.g., by mixing the x-rays having the desired spectral distribution that is characteristic of the at least one second material 122 of the structures 120 with x-rays having a spectral distribution that is characteristic of the x-rays generated by the first material 112 of the substrate 110).

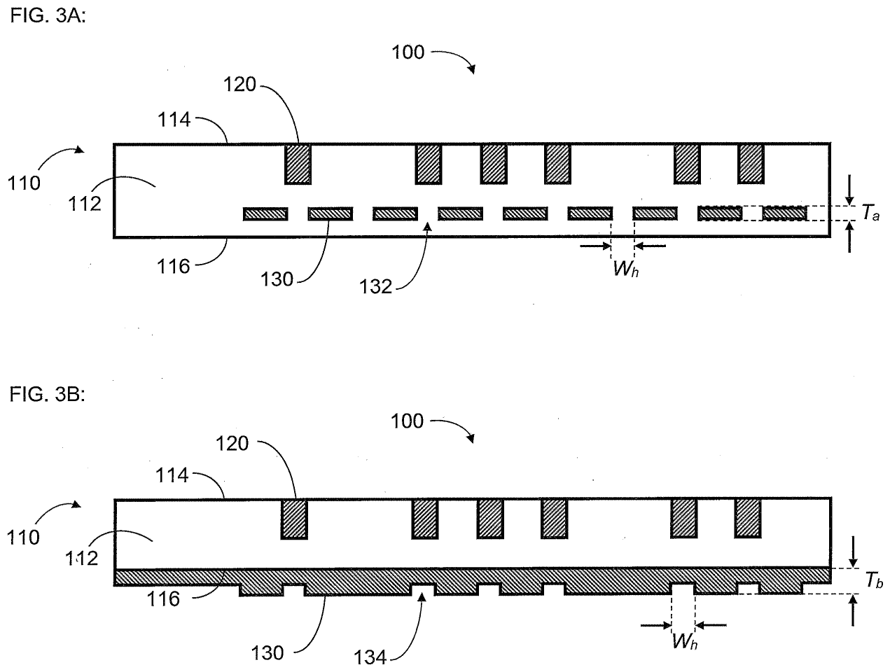

In certain embodiments, the target 100 further comprises one or more x-ray absorption elements 130 configured to prevent (e.g., reduce; block; inhibit) x-rays generated by the substrate 110 (e.g., regions of the substrate 110 between the structures 120) from propagating from the target 100 and degrading the resultant x-ray beam. FIGS. 3A and 3B schematically illustrate two example targets 20 configured to improve the x-ray distribution from the target 100 in accordance with certain embodiments described herein. As schematically illustrated in FIG. 3A, the target 100 comprises at least one layer 130 at a position between the structures 120 and the second surface 116 of the substrate 110. In certain embodiments, the at least one layer 130 effectively blocks many of the x-rays produced in the substrate 110 while allowing transmission of x-rays produced in the structures 120.

The at least one layer 130 of FIG. 3A comprises an x-ray absorbing material (e.g., gold) embedded within the substrate 110, having a thickness Tₐ (e.g., in a range of 10 microns to 30 microns), and comprising holes 132 directly below the structures 120 (e.g., having a pitch of 3 microns and lines of 2 microns). For example, the at least one layer 130 can be formed by depositing a uniform layer onto a back surface of the substrate 110, etching the layer 130 to form the desired microstructure, and then forming additional substrate material over the layer 130 on the back surface to form the second surface 116. Alternatively, a top portion of the substrate 110 and a bottom portion of the substrate 110 can be separately formed, the top portion having the structures 120 and the bottom portion with the at least one layer 130, and the two substrate portions can be joined together (e.g., adhered; clamped). The at least one layer 130 can have an aspect ratio defined by the thickness Tₐ of the at least one layer 130 divided by the lateral width Wₕ of the holes 132.

As schematically illustrated in FIG. 3B, the at least one layer 130 can comprise an x-ray absorbing material (e.g., gold) deposited on the second surface 116, having a thickness T_{b} (e.g., in a range of 10 microns to 60 microns), and comprising recesses 134 with a lateral width Wₕ positioned directly below the structures 120 (e.g., with a depth in a range of 3 microns to 100 microns). In certain embodiments, the at least one layer 130 also serves as a filter configured to reduce an energy bandwidth of the x-rays (e.g., to filter the x-rays to have a bandwidth of ±15% around an x-ray energy of interest).

In certain embodiments, the array pattern function A of the structures 120 has a corresponding function B such that a combination operation of the array pattern function A with the corresponding function B generates a resultant function C that approximates (e.g., is substantially equal to) a delta function. The combination operation can be selected from the group consisting of: a cross-correlation operation and a convolution operation. The combination of the array pattern function A and the corresponding function B can be described as a “balanced correlation” since the two functions A and B balance one another so that the resultant function approximates a delta function.

For example, the resultant function C comprises a convolution function of the array pattern function A with the corresponding function B: (A*B)(x) [symbol] Σ_{-∞}^{∞} A(p)B(x−ρ)dρ. For another example, the combination operation can comprise a cross-correlation operation and the resultant function C can comprise a cross-correlation function of the array pattern function A with the corresponding function B: (A*B)(x) [symbol] Σ_{-∞}^{∞} A̅(̅ρ̅)̅ B(x+ρ)dρ. In certain such embodiments, the corresponding function B comprises the array pattern function A, so the combination operation comprises the autocorrelation operation and the resultant function C comprises an autocorrelation function of the array pattern function A: (A*A)(x) [symbol] Σ_{-∞}^{∞} A̅(̅ρ̅)̅ A(x+ρ)dρ. In certain other embodiments, the [symbol] corresponding function B comprises a function different from the array pattern function A (e.g., a function similar to, but not identical with, the array pattern function A).

As schematically illustrated by FIG. 1B, the resultant function C 200 of certain embodiments comprises a first portion 210 with a single peak 212 and a substantially flat second portion 220 surrounding the first portion 210. In certain such embodiments, the first portion 210 of the resultant function C has a first maximum magnitude Mₘₐₓ₁ and the second portion 220 of the resultant function C has a second maximum magnitude Mₘₐₓ₂ that is substantially less than the first maximum magnitude Mₘₐₓ₁. For example, the first portion 210 can have a first maximum magnitude Mₘₐₓ₁ and the second portion 220 can have a second maximum magnitude Mₘₐₓ₂ that is less than 10% of the first maximum magnitude M₁ (i.e., Mₘₐₓ₂≤0.1·Mₘₐₓ₁). In certain embodiments, a magnitude of the second portion 220 is constant (e.g., substantially flat) to within ±10%, within ±5%, and/or within 2%. For example, a difference (Mₘₐₓ₂−Mₘᵢₙ₂) between the maximum magnitude Mₘₐₓ₂ of the second portion 220 and a minimum magnitude Mₘᵢₙ₂ of the second portion 220 is within 10%, 5%, and/or 2% of an average ([Mₘₐₓ₂+Mₘᵢₙ₂]/2) of the maximum magnitude Mₘₐₓ₂ and the minimum magnitude Mₘᵢₙ₂.

In certain embodiments, the array pattern function A is designed to optimally preserve the information content of the recorded image (e.g., the image resulting from x-rays generated by the target 100, transmitted through the object being analyzed, and recorded by the x-ray detector) so that the recorded image can be directly imaged or reconstructed. In certain embodiments, the array pattern function A is selected from the group consisting of: uniformly redundant array (URA), modified uniformly redundant array (MURA), hexagonal uniformly redundant array (HURA), dilute uniformly redundant array (DURA), non-redundant array (NRA), cyclic difference array, Singer cyclic difference array, Hadamard cyclic difference array, twin-prime cyclic difference array, m-sequence array, biquadratic array, perfect binary array (PBA), product array, pseudo-noise product (PNP) array, M-P array, M-M array, new system (NS) array, no-two-holes-touching (NTHT) array, two-scale array, random array (e.g., the location and quantity of the structures 120 are selected from a uniform, gaussian, or other probability distribution), pseudorandom array (e.g., a random array which has been subsequently refined using simulated annealing or other optimization algorithm to make the autocorrelation of the array more closely approximate a delta function), and any combination thereof.

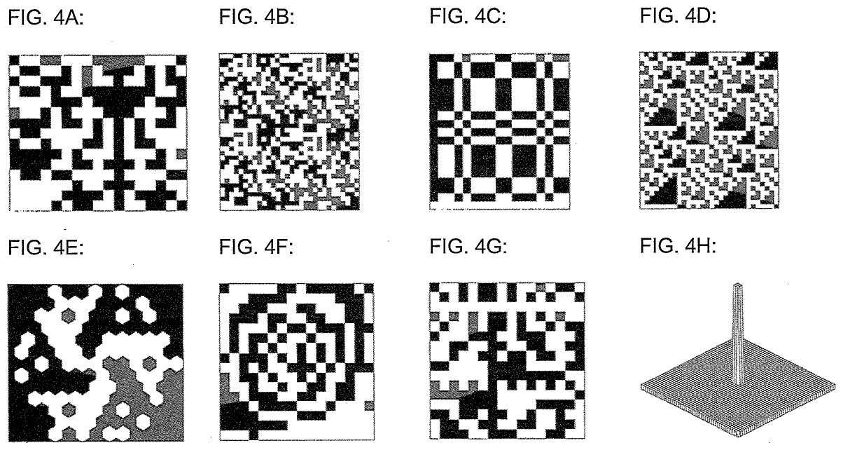

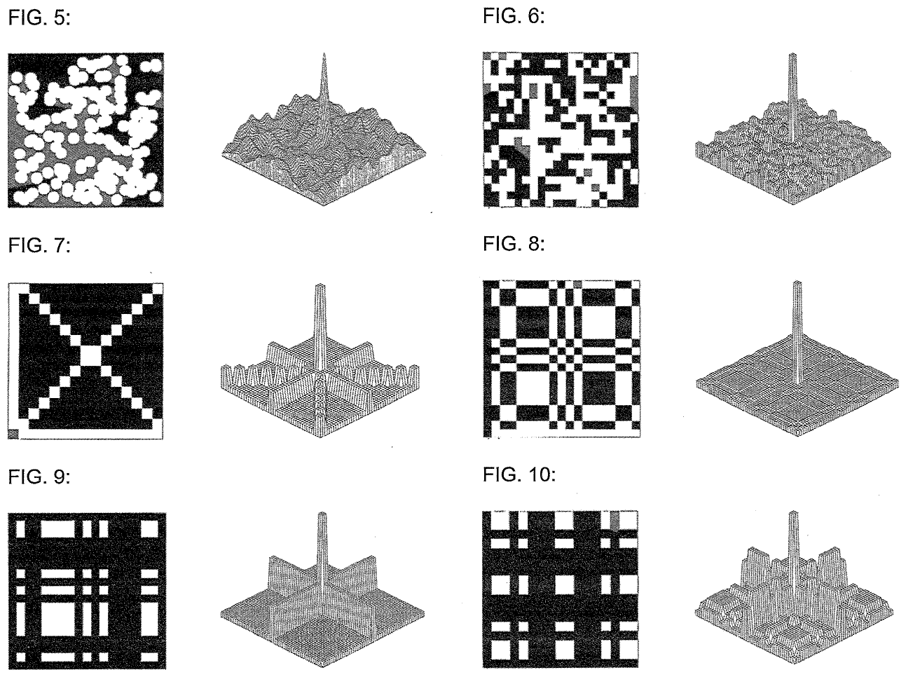

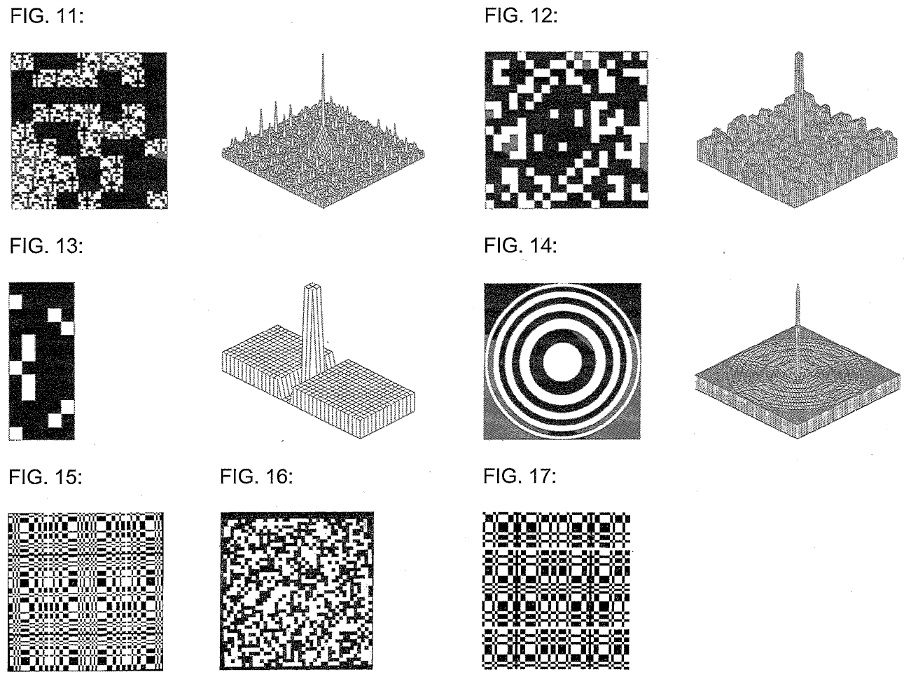

Example array pattern functions A in accordance with certain embodiments described herein can be based on binary arrays that have been disclosed for use in coded aperture imaging. For example, FIGS. 4A-4G illustrate top views of various example two-dimensional array pattern functions A in accordance with certain embodiments described herein. Each of the array pattern functions A of FIGS. 4A-4G has an autocorrelation function (C=A*A) that is substantially the same as one another, an example of which is illustrated by FIG. 4H. FIGS. 5-14 illustrate various example two-dimensional array pattern functions A in accordance with certain embodiments described herein along with the corresponding autocorrelation functions (C=A*A) for each of the array pattern functions A. The array pattern functions A and the autocorrelation functions of FIGS. 4-14 are based on the binary arrays described more fully (in the context of coded aperture imaging) by G. K. Skinner and R. M. Rideout, “A Compendium of Coded Mask Designs,” in Imaging in High Energy Astronomy, L. Bassani and G. di Cocco (eds.), pp. 177-182 (1995) (incorporated in its entirety by reference herein) and the references cited therein. FIGS. 15-16 illustrate additional example two-dimensional array pattern functions A in accordance with certain embodiments described herein and which are based on binary arrays described more fully by E. E. Fenimore and T. M. Cannon, “Coded aperture imaging with uniformly redundant arrays,” Appl. Op. Vol. 17, No. 3, pp. 337-347 (1978) (incorporated in its entirety by reference herein). FIG. 17 illustrates an additional example two-dimensional array pattern function A in accordance with certain embodiments described herein and which is based on a binary array described more fully by E. E. Fenimore, “Coded aperture imaging: the modulation transfer function for uniformly redundant arrays,” Appl. Op. Vol. 19, No. 4, pp. 2465-2471 (1980) (incorporated in its entirety by reference herein).

In certain embodiments, the dark portions of the array pattern functions A of FIGS. 4-17 correspond to the structures 120 and the white portions of the array pattern functions A correspond to the regions without the structures 120. In certain other embodiments, the white portions of the array pattern functions A of FIGS. 4-17 correspond to the structures 120 and the dark portions of the array pattern functions A correspond to the regions without the structures 120. In certain embodiments, the array pattern function A has an area fraction (e.g., the cumulative areas of the structures 120 in a plane parallel to the first surface 114 divided by the total area of the array pattern function A) that is in a range of 10% to 60%.

Other example array pattern functions A in accordance with certain embodiments described herein can be based on coded aperture imaging arrays described more fully by S. R. Gottesman and E. E. Fenimore, “New family of binary arrays for coded aperture imaging,” Appl. Op., Vol. 28, No. 20, pp. 4344-4352 (1989); E. Carolli et al., “Coded Aperture Imaging in X- and Gamma-Ray Astronomy,” Space Science Reviews Vol. 45, pp. 349-403 (1987); R. Accorsi, “Design of Near-Field Coded Aperture Cameras for High-Resolution Medical and Industrial Gamma-Ray Imaging,” thesis submitted to the Department of Nuclear Engineering at Massachusetts Institute of Technology (June 2001); U.S. Pat. Nos. 4,389,633; 4,360,797; 4,228,420; 4,209,780; 6,737,652, each of which is incorporated in its entirety by reference herein.

In certain embodiments, the structures 120 are arranged as a plurality of n sub-arrays, each sub-array having an array pattern function Aₙ that has a corresponding function Bₙ such that a combination operation (e.g., a cross-correlation operation or a convolution operation) of the array pattern function Aₙ with the corresponding function Bₙ generates a resultant function Cₙ that approximates (e.g., is substantially equal to) a delta function. For example, a first set of discrete structures 120 can be distributed across a first region of the first surface 114 in a first sub-array and a second set of discrete structures 120 can be distributed across a second region of the first surface 114 in a second sub-array. In certain embodiments, the second sub-array is equal to at least a portion of the first sub-array (e.g., equal to the whole first sub-array). For example, the plurality of sub-arrays can repeat a common array pattern function A across the first surface 114 (e.g., with periodic boundary conditions between the plurality of sub-arrays). In certain other embodiments, the second sub-array can be equal to an inverse or negative of the first sub-array (e.g., the first sub-array can have a first array pattern function A₁ comprising regions with structures 120 and regions without structures 120 and the second sub-array can have a second array pattern function A₂ equal to the first array pattern function A₁ but with the regions with structures 120 and the regions without structures 120 switched with one another). In certain embodiments, the plurality of sub-arrays are arranged in a mosaic (e.g., adjacent sub-arrays border one another; the perimeters of adjacent sub-arrays share a common portion).

In certain embodiments, the target 100 further comprises a second plurality of discrete structures 120 configured to generate x-rays in response to electron bombardment, the second plurality of discrete structures arranged in a periodic array pattern. For example, a first plurality of discrete structures 120 can be distributed across a first region of the first surface 114 in a first sub-array with the array pattern function A and the second plurality of discrete structures 120 can be distributed across a second region of the first surface 114 in a second sub-array with a periodic array pattern (e.g., in a two-dimensional rectangular grid pattern). In certain such embodiments, the target 100 and/or the at least one electron beam 312 can be moved relative to the other to selectively bombard either the first plurality of discrete structures 120 (e.g., to be used as a coded x-ray target) or the second plurality of discrete structures 120 (e.g., to be used as a Talbot-Lau x-ray source).

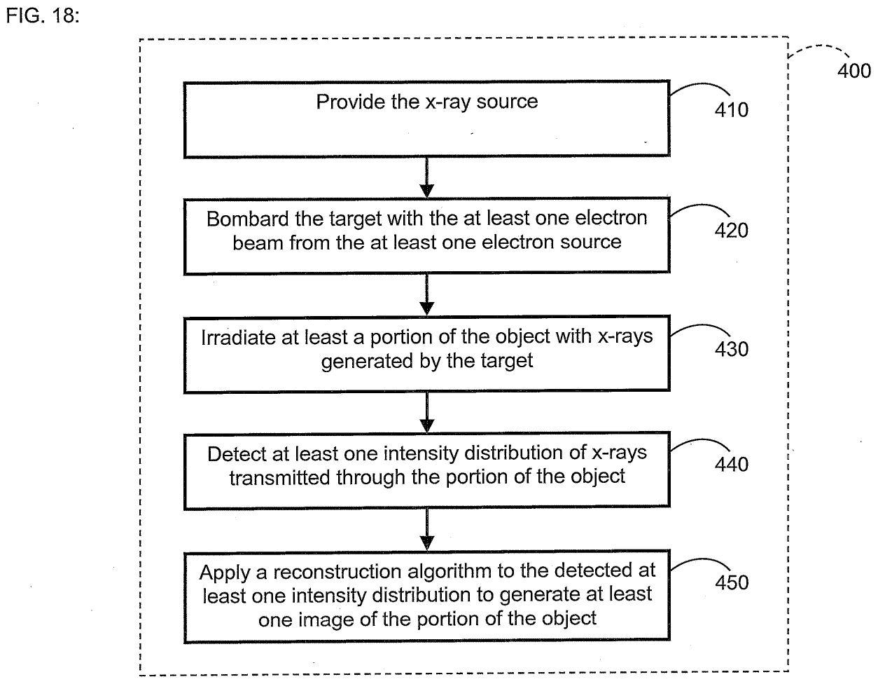

FIG. 18 is a flow diagram of an example method 400 for analyzing an object in accordance with certain embodiments described herein. In an operational block 410, the method 400 comprises providing the x-ray source 300, and in an operational block 420, bombarding the target 100 with the at least one electron beam 312 from the at least one electron source 310. In an operational block 430, the method 400 further comprises irradiating at least a portion of the object 330 with x-rays 320 generated by the target 100 in response to said bombarding. In an operational block 440, the method 400 further comprises detecting at least one intensity distribution of x-rays 340 transmitted through the portion of the object 330. In an operational block 450, the method 400 further comprises applying a reconstruction algorithm to the detected at least one intensity distribution to generate at least one image of the portion of the object 330.

In certain embodiments, a measurement comprises placing the object 330 between the x-ray source 300 and the x-ray detector 350, irradiating the object 330 with the x-ray beam 320 and acquiring an image using the x-ray detector 350 to detect the x-rays 340 transmitted through the object 330 (see, e.g., FIGS. 2A and 2B).

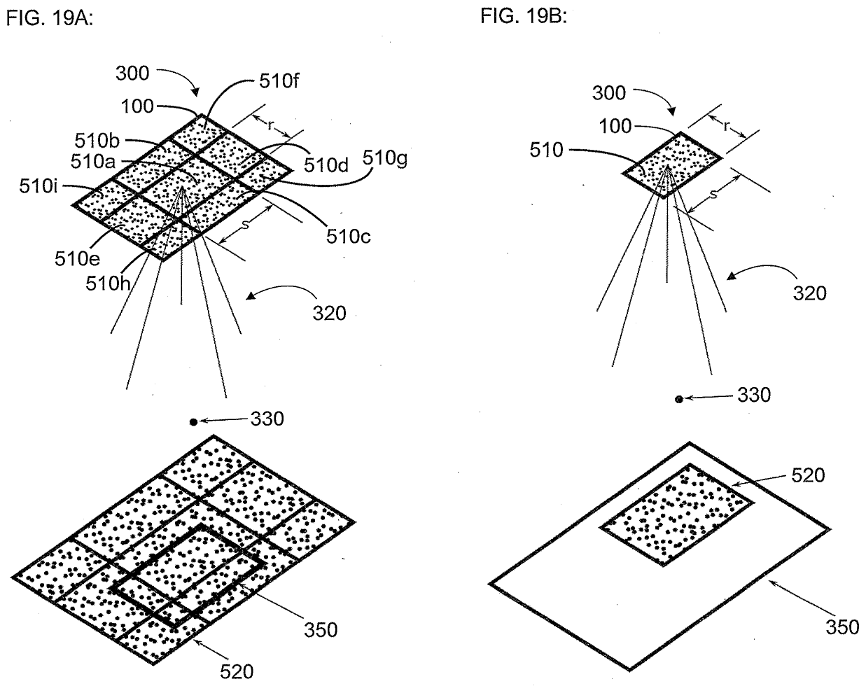

FIGS. 19A and 19B schematically illustrate two example configurations of the x-ray source 300, the object 330 being analyzed, and the x-ray detector 350 in accordance with certain embodiments described herein. The x-ray source 300 of FIG. 19A comprises a mosaic tiled (e.g., in a cyclic pattern; with a periodic boundary condition) x-ray target 100. The target 100 comprises a first set of discrete structures 120 distributed in a first sub-array 510a (e.g., abase r×s unit) having a first array pattern function Aₐ. The first sub-array 510a is bordered on each side by four other sets of discrete structures 120 distributed in corresponding sub-arrays 510b-e. Each sub-array 510b-e has a corresponding array pattern function A_{b}, A_{c}, A_{d}, Aₑ that is a one-half portion of the first array pattern function Aₐ. For example, the array pattern functions A_{b} and Aₑ are respective one-half portions

$$( e . g . , \frac{r}{2} \times s )$$

of the first array pattern function Aₐ and the array pattern functions A_{d} and Aₑ are respective one-half portions

$$( e . g . , r \times \frac{s}{2} )$$

of the first array pattern function Aₐ. In addition, the mosaic x-ray target 100 of FIG. 19A further comprises four sets of discrete structures 120 distributed in corresponding sub-arrays 510f-i that each share a corner with the first sub-array 510a and border two of the sub-arrays 510b-e. Each sub-array 510f-i has a corresponding array pattern functions A_{f}, A_{g}, Aₕ, Aᵢ that is a one-quarter portion

$$( e . g . , respective \frac{r}{2} \times \frac{s}{2} )$$

of the first array pattern function Aₐ. The x-ray source 300 is configured to irradiate the object 330, which projects a shadow image 520 comprising the transmitted x-rays 340 onto the x-ray detector 350. In the configuration of FIG. 19A, the portion of the object 330 is positioned entirely within the field of view of the x-ray source 300 and the size of the x-ray detector 350 is sufficient to capture one complete repetition of the base r×s unit (e.g., the x-ray detector 350 is large enough to capture a portion of the shadow image 520 that corresponds to a single tile of the tiled x-ray target 100.

The x-ray source 300 of FIG. 19B comprises an x-ray target 100 comprising a single set of discrete structures 120 distributed in a single array 510 having an array pattern function A. The x-ray source 300 is configured to irradiate the object 330, which projects the shadow image 520 comprising the transmitted x-rays 340 onto the x-ray detector 350. In the configuration of FIG. 19B, the x-ray detector 350 is sufficiently large to capture the complete shadow image 520 projected from any point in the object 330 (e.g., large enough to measure the convolution of the x-ray source 300 with the portion of the object 330). The configuration of FIG. 19B advantageously results in a smaller, and therefore brighter, x-ray source 300, and using an x-ray detector 350 with a sufficiently large detector area is generally easy to accommodate.

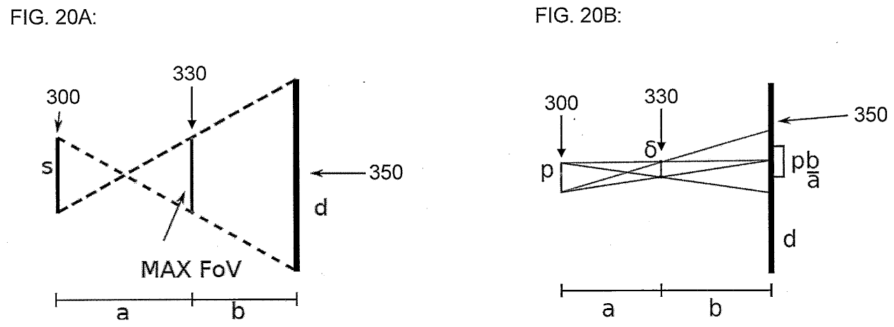

FIGS. 20A and 20B schematically illustrate two example configurations of the x-ray source 300 and the x-ray detector 350 depicting a geometric field of view and resolution limit in accordance with certain embodiments described herein. In both FIGS. 20A and 20B, the x-ray source 300 and the x-ray detector 350 are planar and are substantially parallel to one another, and the object 330 is a distance a from the x-ray source 300 and a distance b from the x-ray detector 350 (e.g., along a direction perpendicular to the x-ray source 300 and the x-ray detector 350).

FIG. 20A depicts the geometric field of view in accordance with certain embodiments described herein. In FIG. 20A, the structures 120 of the x-ray source 300 are distributed across a planar area having a size s (e.g., a width of the planar area of the array pattern function A) and the x-ray detector 350 has a planar area parallel to that of the x-ray source 300 having a size d (e.g., a width of the planar area of the pixels). The source size s and the detector size d define a limit to the maximum reconstructable field of view (labeled “MAX FoV” in FIG. 20A), which can be referred to as the Fully Coded Field of View (FCFV). Any portion of the object 330 outside the dashed lines of FIG. 20A does not project a complete image of the array pattern function A onto the x-ray detector 350 and cannot be fully reconstructed, resulting in a Partially Coded Field of View (PCFV).

The FCFV can be related to the source size s and the detector size d by the relation:

$$\frac{d}{2} - \frac{b + a}{a} \cdot \frac{FCFV}{2} = \frac{b}{a} \cdot \frac{s}{2} ,$$

which can be simplified to:

$$FCFV = \frac{d - M \cdot s}{M + 1} ,$$

where M=b/a. For M=0, the FCFV reduces to d, and for M=1, the FCFV is to (d−s)/2 and reduces to s for large M. In certain embodiments in which a small source size s is used, it can be advantageous to keep M as low as possible (e.g., small distance b and/or large distance a) since for large values of M, the field of view shrinks to s and for small values of M, a larger field of view is obtained.

FIG. 20B depicts the geometric resolution in accordance with certain embodiments described herein. To resolve two features in the object 330 that are separated from one another by distance δ, the images of these two features in certain embodiments are separated by more than the size p of a single pixel feature in the x-ray source 300 magnified to the detector plane (e.g., M·p). Using the relation

$$\frac{a + b}{b} \cdot δ = \frac{b}{a} \cdot p ,$$

the distance δ can be expressed as:

$$δ = \frac{M \cdot p}{M + 1} .$$

For M=0, δ=0 (e.g., corresponding to a contact image), and for M=1, the maximum achievable resolution is one-half the pixel size (p/2). In addition, as M→∞, the distance δ→p, so in certain embodiments, it can be advantageous to keep M as low as possible (e.g., small distance b and/or large distance a). For example, pixel sizes in the range of 0.5 micron to 5 microns can be used, providing resolutions in the range of 0.1 micron to 5 microns.

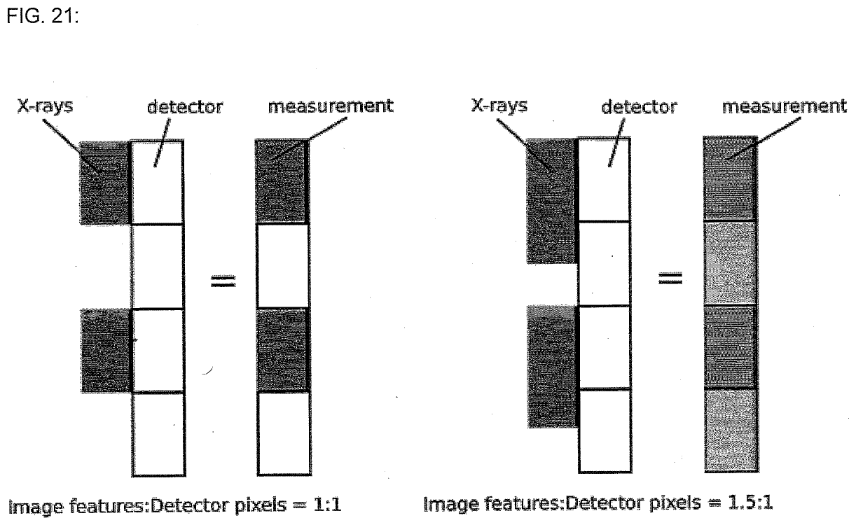

Certain embodiments described herein have an integer ratio of the size of the structures 120 of the x-ray source 300 (e.g., the source pixel size) to the pixel size of the x-ray detector 350. Certain other embodiments described herein have an integer ratio of the pixel size of the x-ray detector 350 to the size of the structures 120 of the x-ray source 300 (e.g., the source pixel size). For example, as schematically illustrated in FIG. 21, for high contrast binary patterns in the array function pattern A, if the detector pixel size is an integer multiple of the magnified source pixel (see left side of FIG. 21), the resulting image has a higher contrast than if the detector pixel size is not an integer multiple of the magnified source pixel (see right side of FIG. 21). In the non-integer multiple configuration, an image feature is spread across two or more pixels which thereby lowers the contrast and distorts the resultant image.

In certain embodiments, the reconstruction algorithm applied to the detected at least one intensity distribution to generate at least one image of the portion of the object 330 is iterative, while in certain other embodiments, the reconstruction algorithm is analytical. The reconstruction algorithm can be selected from the group consisting of: correlation, deconvolution (e.g., Wiener deconvolution), maximum likelihood estimation, and any combination thereof. For example, the reconstruction algorithm can comprise applying the corresponding function B (e.g., via correlation, deconvolution, maximum likelihood estimation, and any combination thereof) to the measured intensity to generate the at least one image. In certain embodiments, the reconstruction algorithm further comprises an iterative refinement of the at least one image.

In certain embodiments, the array function pattern A has the property that there is a corresponding function B for which the following relation is true: A*B=δ, where δ is the delta function and (A*B)(x) [symbol] Σ_{-∞}^{∞} A̅(̅ρ̅)̅ B(x+ρ)dρ. For example, in certain embodiments in which the object 330 and the x-ray detector 350 are sufficiently far from the x-ray source 300 for the far-field approximation to be valid, the measured x-ray intensity I can be related to the x-ray source intensity S (e.g., ideally corresponding to the array pattern function A) and the x-ray transmissivity O of the object 330 as: I=S*O. A similar expression applies in the near-field limit, but with some additional factors that do not fundamentally alter the relationship between the measured x-ray intensity I, the x-ray source intensity S, and the x-ray transmissivity O of the object 330. In certain such embodiments, the object image can be retrieved from the measured x-ray intensity I by using the relation: I*B=S*O*B=O.

In certain other embodiments, the actual measurements are made under non-ideal conditions, examples of which include but are not limited to: less-than-perfect x-ray production contrast between the structures 120 and the substrate 110, unintended deviations during manufacture of the x-ray source intensity S from the design parameters of the array pattern function A, non-uniform electron bombardment, detector noise, etc. In certain such embodiments, the measured intensity I can be approximated by: I=S*O+∈, where ∈ is a spatially varying function that represents the effects of the non-ideal conditions on the measured intensity I. In certain such embodiments, correlating the measured intensity I with the decoding function B enables recovery of a corrupted image of the object 350 as follows: I*B=A*O*B+∈*B=O+∈*B. In certain embodiments, an iterative scheme is used to correct the error term ∈*B by incorporating multiple measurements.

For example, the multiple measurements can be acquired as a function of object rotation I_{θ} by rotating the object 330 relative to the x-ray target 100 (e.g., about an axis), and the irradiation of the object 330 is performed with the object 330 having multiple orientations relative to the x-ray target 100. The x-ray detector 350 can be used to generate multiple detected intensity distributions corresponding to the multiple orientations. In certain such embodiments, an iterative reconstruction of the rotation series of measurements (e.g., tomography) can be performed using the following relations:

Oₙ=R_{θ}⁻¹[I_{θ}*B]

Oₙ₊₁=Oₙ+R_{θ}⁻¹[I_{θ}−R_{θ}^{±1}[Oₙ]*B]

where R_{θ}^{±1} indicates the forward/reverse radon transform. Applying the reconstruction algorithm to the multiple detected intensity distributions can generate multiple images of the portion of the object 330, and the multiple images can be used to generate a three-dimensional tomography image of the portion of the object 330.

For another example, the multiple measurements can be acquired as a function of translation Iᵣ of the electron beam 312 of the x-ray source 300 (e.g., along a direction across the first surface 114 of the x-ray target 100). In certain such embodiments, the iterative reconstruction of a translation series of measurements can be performed using the following relations:

$${O}_{n} = {\sum }_{r} [ {I}_{r} ★ B ]$$

$${O}_{n + 1} = {O}_{n} + {\sum }_{r} [ {I}_{r} - [ {O}_{n} ] ★ B ]$$

where {Iᵣ} is the set of measurements acquired by translating the electron beam 312 across the structures 120 arranged in the array pattern function A.

Various configurations have been described above. Although this invention has been described with reference to these specific configurations, the descriptions are intended to be illustrative of the invention and are not intended to be limiting. Various modifications and applications may occur to those skilled in the art without departing from the true spirit and scope of the invention. Thus, for example, in any method or process disclosed herein, the acts or operations making up the method/process may be performed in any suitable sequence and are not necessarily limited to any particular disclosed sequence. Features or elements from various embodiments and examples discussed above may be combined with one another to produce alternative configurations compatible with embodiments disclosed herein. Various aspects and advantages of the embodiments have been described where appropriate. It is to be understood that not necessarily all such aspects or advantages may be achieved in accordance with any particular embodiment. Thus, for example, it should be recognized that the various embodiments may be carried out in a manner that achieves or optimizes one advantage or group of advantages as taught herein without necessarily achieving other aspects or advantages as may be taught or suggested herein.

What is claimed is:

1. A target for generating x-rays, the target comprising:
at least one substrate comprising a first material; and
a plurality of discrete structures comprising at least one second material configured to generate x-rays in response to electron bombardment, the discrete structures distributed across a first surface of the at least one substrate in an array pattern function A that has a corresponding function B such that a combination operation of the array pattern function A with the corresponding function B generates a resultant function C comprising a first portion with a single peak and a substantially flat second portion surrounding the first portion, the combination operation comprising a cross-correlation operation or a convolution operation.

2. The target of claim 1, wherein the array pattern function A, the corresponding function B, and the resultant function C are two-dimensional.

3. The target of claim 2, wherein the array pattern function A is selected from the group consisting of: uniformly redundant array (URA), modified uniformly redundant array (MURA), hexagonal uniformly redundant array (HURA), dilute uniformly redundant array (DURA), non-redundant array (NRA), cyclic difference array, Singer cyclic difference array, Hadamard cyclic difference array, twin-prime cyclic difference array, m-sequence array, biquadratic array, perfect binary array (PBA), product array, pseudo-noise product (PNP) array, M-P array, M-M array, new system (NS) array, no-two-holes-touching (NTHT) array, two-scale array, random array, pseudorandom array, and any combination thereof.

4. The target of any preceding claim, wherein the array pattern function A has an area fraction that is in a range of 10% to 60%.

5. The target of any preceding claim, wherein the corresponding function B equals the array pattern function A and the resultant function C equals an autocorrelation function of the array pattern function A.

6. The target of any preceding claim, wherein the resultant function C is substantially equal to a delta function.

7. The target of claim 6, wherein the first portion of the resultant function C has a first maximum magnitude and the second portion has a second maximum magnitude that is substantially less than the first maximum magnitude.

8. The target of claim 7, wherein the second maximum magnitude is less than 10% of the first maximum magnitude.

9. The target of any preceding claim, wherein a magnitude of the second portion is constant to within ±5%.

10. The target of any preceding claim, wherein the discrete structures are adhered to or at least partially embedded in the first surface.

11. The target of any preceding claim, wherein the discrete structures are rectangular and the plurality of discrete structures are distributed in a rectangular area across the first surface.

12. The target of any preceding claim, wherein a first set of the discrete structures are distributed across a first region of the first surface in a first sub-array and a second set of the discrete structures are distributed across a second region of the first surface in a second sub-array.

13. The target of claim 12, wherein the second sub-array is equal to an inverse of the first sub-array.

14. The target of claim 12, wherein the second sub-array is equal to at least a portion of the first sub-array.

15. The target of claim 12, wherein the second sub-array is equal to the first sub-array.

16. The target of any preceding claim, wherein the first material comprises diamond or beryllium and the at least one second material comprises tungsten or molybdenum.

17. The target of any preceding claim, wherein the at least one second material is in thermal communication with the first material.

18. The target of any of claims 1 to 17, wherein each discrete structure of the plurality of discrete structures has a length and a width in two orthogonal directions along the first surface, the length in a range of 0.1 micron to 1 micron and the width in a range of 0.1 micron to 1 micron.

19. The target of any of claims 1 to 17, wherein each discrete structure of the plurality of discrete structures has a length and a width in two orthogonal directions along the first surface, the length in a range of 0.1 micron to 100 microns and the width in a range of 0.1 micron to 100 microns.

20. The target of any preceding claim, wherein each discrete structure of the plurality of discrete structures has a thickness in a direction perpendicular to the first surface, the thickness in a range of 1 micron to 40 microns.

21. The target of any preceding claim, wherein the at least one substrate comprises a second surface opposite to the first surface, the target further comprising at least one layer on the second surface, the at least one layer comprising at least one first region that is substantially opaque to x-rays and is configured to attenuate x-rays generated by electron bombardment of the second material and at least one second region that is substantially transmissive to x-rays generated by the plurality of discrete structures.

22. The target of any preceding claim, further comprising a second plurality of discrete structures configured to generate x-rays in response to electron bombardment, the second plurality of discrete structures arranged in a periodic array pattern.

23. An x-ray source comprising:
a target of any preceding claim; and
at least one electron source configured to generate at least one electron beam and to bombard the target with the at least one electron beam.

24. The x-ray source of claim 23, wherein the at least one electron beam is incident upon the target along a direction that is normal to the first surface.

25. The x-ray source of claim 23, wherein the at least one electron beam is incident upon the target along a direction that is non-normal to the first surface.

26. The x-ray source of any of claims 23 to 25, wherein the at least one electron beam has a cross-sectional area in a plane substantially perpendicular to a propagation direction of the at least one electron beam, the cross-sectional area greater than or equal to an area of the array pattern function A across the first surface.

27. The x-ray source of claim 26, wherein the cross-sectional area has a width that is greater than or equal to 1 micron, greater than or equal to 100 microns, or greater than or equal to 250 microns.

28. A method comprising:
providing an x-ray source of any of claims 23 to 27;
bombarding the target with the at least one electron beam from the at least one electron source;
irradiating at least a portion of an object with x-rays generated by the target in response to said bombarding;
detecting at least one intensity distribution of x-rays transmitted through the portion of the object; and
applying a reconstruction algorithm to the detected at least one intensity distribution to generate at least one image of the portion of the object.

29. The method of claim 28, wherein the reconstruction algorithm is iterative or analytical.

30. The method of claim 28 or claim 29, wherein the reconstruction algorithm is selected from the group consisting of: correlation, deconvolution, maximum likelihood estimation, and any combination thereof.

31. The method of any of claims 28 to 30, wherein the reconstruction algorithm comprises using the corresponding function B to generate the at least one image.

32. The method of claim 31, wherein the reconstruction algorithm further comprises an iterative refinement of the at least one image.

33. The method of any of claims 28 to 32, further comprising rotating the object relative to the target, wherein said irradiating is performed with the object having multiple orientations relative to the target, said detecting is performed to generate multiple detected intensity distributions corresponding to the multiple orientations, said applying the reconstruction algorithm is performed to the multiple detected intensity distributions to generate multiple images of the portion of the object, and the method further comprising using the multiple images to generate a three-dimensional tomography image of the portion of the object.
